(19) United States
(12) Patent Application Publication
(10) Pub. No.: US 2020/0051242 A1
(43) Pub. Date: Feb. 13, 2020

(54) DETERMINING RISK POSED BY VEGETATION

(71) Applicant: Point4UK Ltd., Grantham (GB)

(72) Inventor: Martin STANLEY, Grantham (GB)

(73) Assignee: Point4UK Ltd., Grantham (GB)

(21) Appl. No.: 16/607,724

(22) PCT Filed: Apr. 24, 2018
(86) PCT No.: PCT/GB2018/051074

§ 371 Date: Oct. 24, 2019

(30) Foreign Application Priority Data
Apr. 24, 2017 (GB) 1706479.1

(51) Int. Cl. G06T 7/00; G01S 17/89

(52) U.S. Cl. CPC G06T 7/0012; G01S 17/89; G06T 2207/10036; G06T 2207/10028; G06T 2207/20081; G06T 2207/10048; G06T 2207/30188

(57) ABSTRACT

The present invention relates to a method of determining the risk to an item posed by vegetation, the method comprising: receiving passive high altitude data, such as satellite imagery, relating to vegetation around the item; determining at least one vegetation feature based on said data; determining a risk posed to the item based on said at least one vegetation feature; and outputting said risk to a user. The invention also relates to a corresponding system and computer program product.

### FIELD OF INVENTION

This invention relates to a system, apparatus and method for determining risks posed to an item by vegetation.

### BACKGROUND

Vegetation can pose risk to items in numerous different ways, for example, as a fall risk onto items (such as property), or roots of vegetation encroaching onto (and damaging) foundations of a structure or underground services. The nature of the risk and the level of risk is highly dependent on the extent and type of vegetation, as well as numerous other factors. For this reason, detailed property surveys are often undertaken in person so as to attempt to quantify the risk posed by vegetation. However, such surveys are time consuming and expensive. Thus, for many properties a representative (as opposed to bespoke) risk assessment is undertaken which can be inaccurate.

Global warming has also had an impact on this problem as higher ambient temperatures further contribute to vegetation growth; global warming also extends and accelerates the growing season of the surrounding vegetation and may render risk surveys inaccurate sooner than in the past. Global warming also increases the likelihood of extreme weather events (such as droughts and floods) which may affect vegetation and hence the risk posed by them.

There is thus a need to solve or reduce at least some of the aforementioned problems.

According to one aspect of the present invention there is provided a method of determining the risk posed to items by vegetation and influencing factors, the method comprising: receiving passive remotely obtained data (such as satellite data) relating to vegetation around the item; determining at least one vegetation feature based on said (satellite) data; determining a risk based on said at least one vegetation feature; and outputting said risk to a user. In such a way a detailed risk output which covers a wide area can be provided to a user.

For efficiency, said passive high altitude data may be collected from an altitude of at least 10 km (e.g. very high altitude aircraft or drones), or at least 15 km (e.g. high altitude balloons), or at least 500 km (e.g. Earth orbiting craft), or between 160 km to 2,000 km (e.g. low earth orbit satellites). Altitude may be calculated with respect to mean sea level.

Preferably, said passive high altitude data comprises satellite imagery.

Preferably, so as to obtain height data, said passive high altitude data comprises multiple images of the vegetation around the item, said multiple images being taken from different angles. Preferably, said passive high altitude data comprises stereo satellite imagery.

So as to obtain further information about the vegetation, the passive high altitude comprises multispectral imagery and/or hyperspectral imagery.

So as to obtain further information about the vegetation, the passive high altitude data comprises infra-red imagery.

Preferably, so as to determine growth rates, the method comprises receiving further passive high altitude data relating to vegetation around said item, said further passive high altitude data being temporally separated from the passive high altitude data.

Preferably, the method further comprises receiving data relating to soil type around said item. Preferably, the data relating to soil type comprises data relating to soil plasticity around said item.

So as determine climate related risks, the method further comprises receiving climate data and determining at least one vegetation feature based on said climate information.

So as determine weather related risks, the method further comprises receiving weather data and determining at least one vegetation feature based on said weather information.

Preferably, at least one vegetation feature based on said climate or weather information comprises risk of falling, water uptake prediction, and/or future vegetation health.

Preferably, said item comprises property. Preferably, the property comprises a structure such as a building.

So as to determine the vast majority of vegetation based risks, the data around the item comprises data relating to vegetation within 70 m of said item.

So as to determine the majority of vegetation based risks, the data around the item comprises data relating to vegetation within 7 m of said item.

Preferably, the method further comprises receiving LiDAR data relating to vegetation around the item.

For more accurate risk determination, the method comprises determining sub-ground structure based on said LiDAR data, and/or determining vegetation height based on said LiDAR data.

Preferably, the at least one vegetation feature comprises: distance from the item, vegetation height, vegetation density, vegetation type, vegetation life expectancy, vegetation health, vegetation water uptake, and/or vegetation pruning tolerance.

For efficiency and/or accuracy, a trained classifier may be used to determine said at least one vegetation feature from said received satellite data.

For efficiency and/or accuracy, a trained classifier is used to determine the risk profile based on said at least one vegetation feature.

Preferably, the trained classifier comprises a neural network, for example a convolutional neural network.

For improved accuracy over time, the trained classifier is adapted to employ reinforcement learning.

Preferably, the risk comprises a subsidence risk.

Preferably, the risk comprises a current risk posed to the item.

Preferably, the risk comprises a risk posed to the item at a future point in time; preferably the risk comprises a probability of an event occurring within a specified time frame.

For ease of use, the output is provided to a user via a user interface.

Preferably, the method further comprises providing a confidence level associated with said risk. Preferably, in the form of a confidence interval.

So as to assist in mitigating risk, the method may further comprise determining a remedial action in dependence on said risk.

Preferably, the remedial action comprises pruning or removing vegetation around the item and/or planting vegetation around the item.

Preferably, the remedial action is dependent on the type of vegetation.

So as to provide an updated risk output, the method may further comprise the step of receiving updated data following remedial action and determining one or more updated vegetation features in dependence on said updated data.

Preferably, the method further comprises the step of determining an updated risk in dependence on said at least one updated vegetation feature.

According to another aspect of the present invention there is provided a system for determining the risk posed to an item by vegetation, the system comprising: means for receiving passive high altitude data, such as satellite imagery, relating to vegetation around the item; means for determining at least one vegetation feature based on said data; means for determining a risk based on said at least one vegetation feature; and means for outputting said risk to a user. Such a system allows a detailed risk output which covers a wide area to be provided to a user.

Preferably, the system further comprises at least on satellite adapted to provide passive high altitude data relating to vegetation around the item. Preferably, the satellite comprises a multispectral camera.

Preferably, the means for receiving passive high altitude comprises a satellite base station.

Preferably, the system further comprises means for receiving LiDAR data.

The invention extends to any novel aspects or features described and/or illustrated herein. Further features of the invention are characterised by the other independent and dependent claims.

Any feature in one aspect of the invention may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

The invention extends to methods and/or apparatus substantially as herein described with reference to the accompanying drawings.

The invention will now be described by way of example with reference to the following Figures:

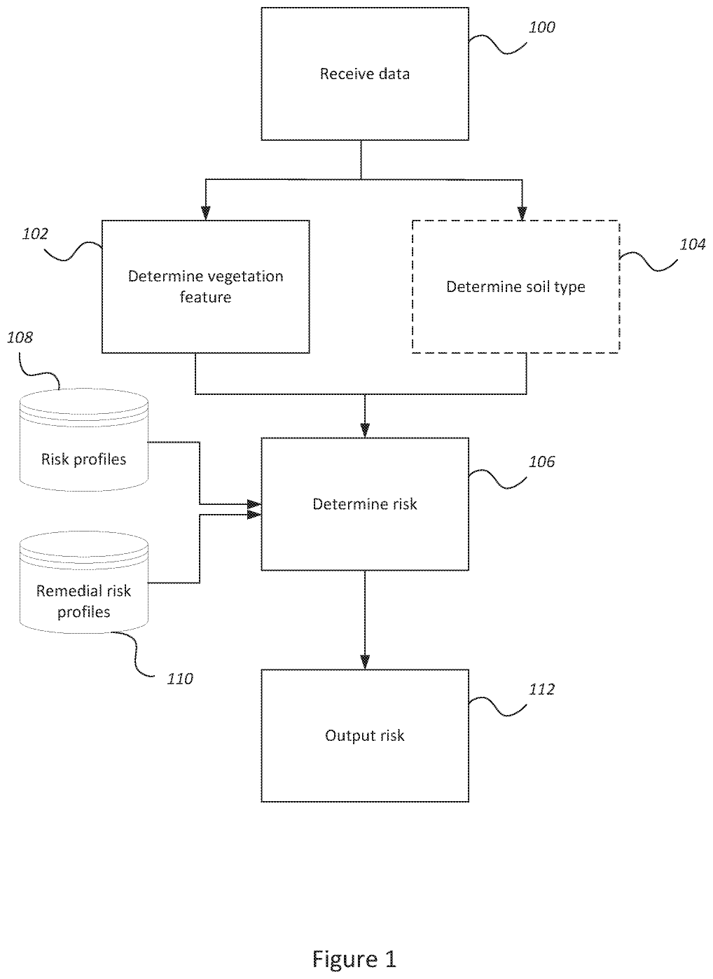

FIG. 1 shows a flow diagram of a method for determining the risk posed to property by vegetation based on at least one vegetation feature;

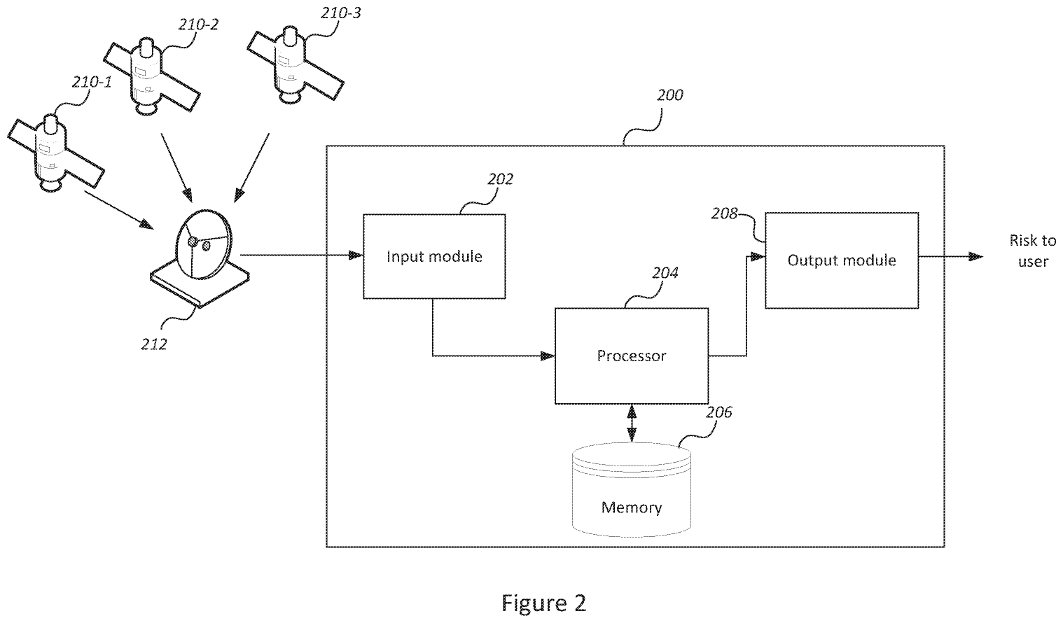

FIG. 2 shows an apparatus 200 adapted to carry out the method described with reference to FIG. 1;

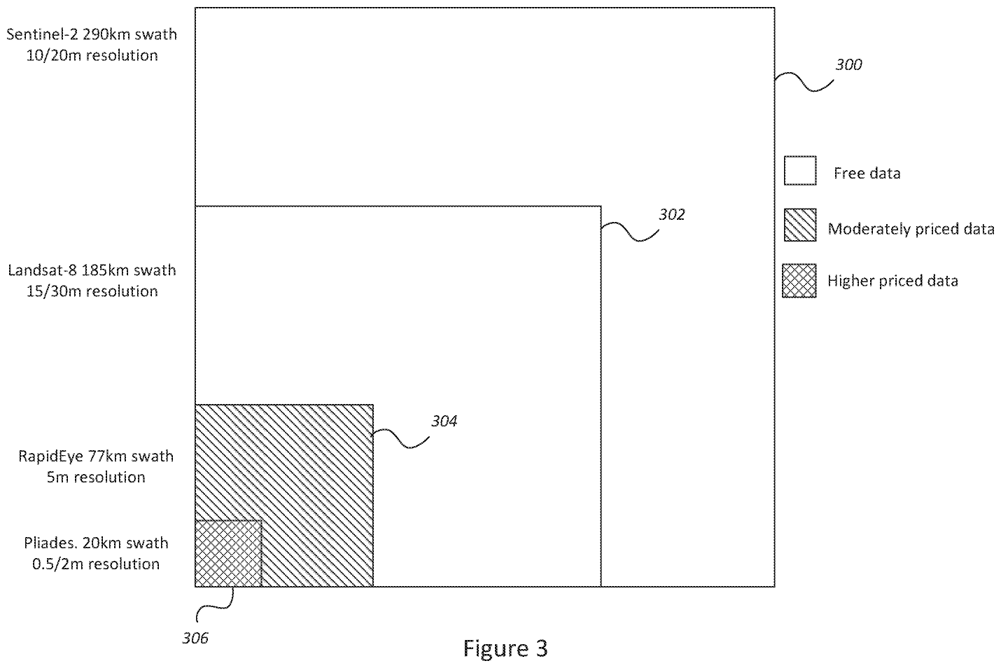

FIG. 3 shows swath sizes and resolutions for four example satellite systems;

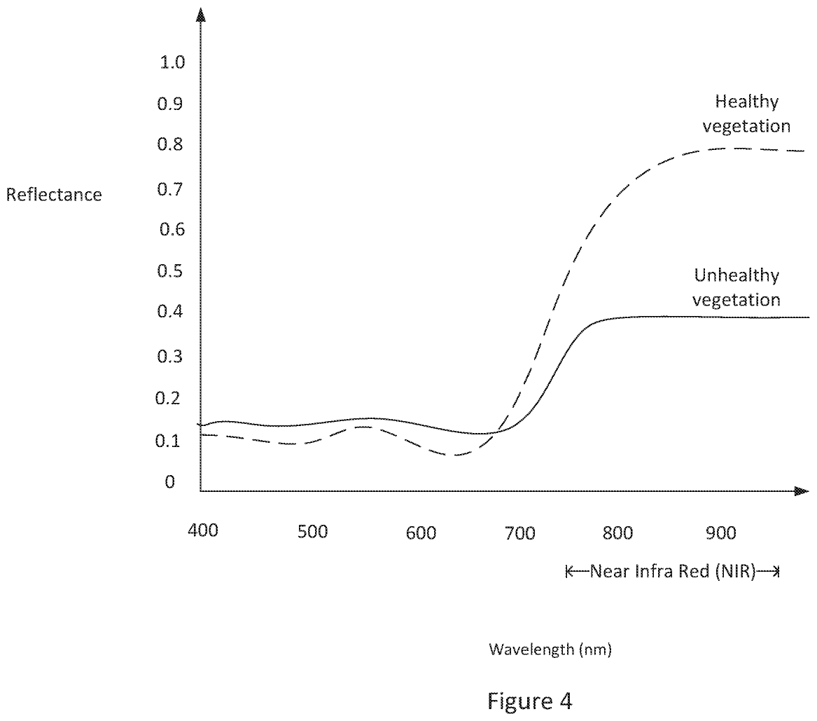

FIG. 4 is a graph showing reflectivity across a range of wavelengths for exemplary healthy and unhealthy vegetation; and

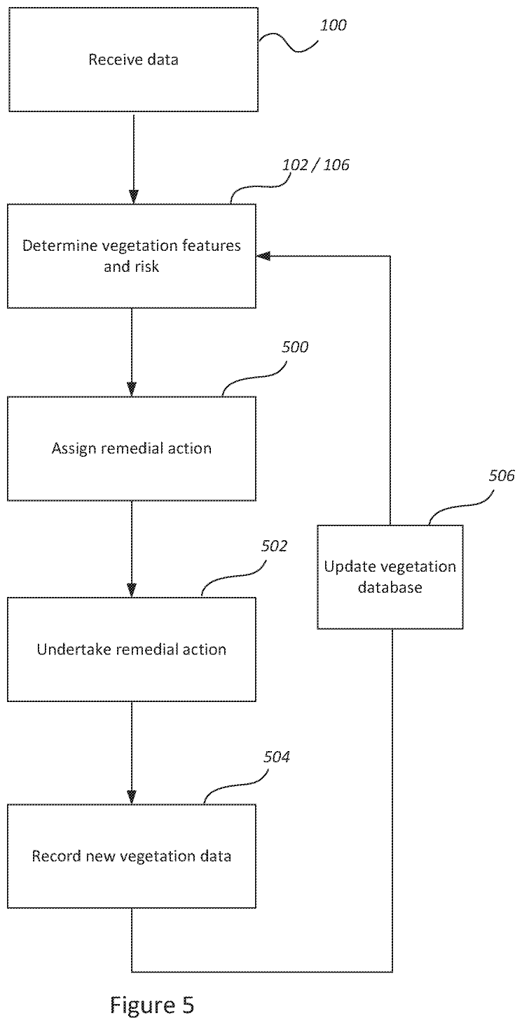

FIG. 5 shows an extended method as shown in FIG. 1 when remedial action is undertaken.

### DETAILED DESCRIPTION

In this specification, the term ‘vegetation’ may refer to any type of vegetation, including trees, tree crowns, bushes, weeds, grass, vines and also to non-living vegetation such as dead trees or dead branches.

As used herein the term ‘item’ or ‘property’ may refer to buildings, or other structures (including temporary structures); or items such as vehicles, boats, trains, construction materials which are being stored, livestock, or arable land.

In overview, the present invention relates to ‘risk banding’ a property based on remote observations (including, for example satellite data). The method described herein provides a more scientific, efficient and transparent method for doing so compared to either a surveyor visiting a property, or a representative (as opposed to bespoke) risk assessment being used.

One particularly difficult risk to determine is that of subsidence due to shrinkable clay soils. This is the largest ground instability issue affecting residential properties in the UK—with rectification costs averaging around £250 m per annum. Research by the insurance sector (Swiss RE and Lloyds of London) indicates that the extent of subsidence both for the UK and Europe will worsen in line with climate change forecast. The insurance industry also recognises the need for significantly improved profiling and predictive tools to identify and target risk mitigation management.

Although climate warming and shrinkable clays soils are two major contributing factors to ground instability and subsidence, vegetation its proximity to property, water demand and health contribute further to the problem, and are indeed key factors to profiling of risk.

Tree roots are a principle source of damage to buildings both in terms of water uptake and physical damage. Resolving the conflict between the desire to improve the urban environment by planting trees and the need to prevent consequential damage is an important planning requirement.

FIG. 1 shows a flow diagram of a method for determining the risk posed to property by vegetation based on at least one vegetation feature.

The first step 100 is to receive data for the area around the item of interest. The area in which data is collected for analysis may depend on the type of risk being determined and the type/value of item being assessed. A mature tree (Oak) for example may reach heights of 35 m so a physical safety inspection distance of up to 70 m may be a sufficient area to inspect. Allowing a distance of twice the height of a tree will negate tree catapult debris damaging a property in the event of tree failure in high winds. Willow trees for example, have been recorded damaging property on a shrinkable clay soil at a distance of up to 40 m. However, 50% of all recorded cases of tree damage are within 7 m. Thus, the relevant area may be a locus of up to 70 m, in one example up to 10 m, preferably 7 m from the item; in another example up to 50 m from the item. However, if the item is near to a slope which may be liable to subside, a much larger area may be appropriate.

The data in one example is passive, high altitude data—such as satellite imagery, which may be hyper/multi spectral data. The data is associated with an item by way of a GPS position, or similar geographical location indicator.

The type of data and its collection will be discussed in more detail below.

The second step 102 is to determine at least one vegetation feature based on the data. As used herein the term ‘vegetation feature’ may mean a characteristic or property of a particular element of vegetation (such as a trees, bushes, grass etc.) or collection of vegetation (or lack thereof). Example vegetation features include (but are not limited to):
Vegetation Distance from property—Tree roots grow out radially in all directions from the tree stem up to x2.9 the diameter of the tree canopy or in excess of the trees height. Roots grow predominantly near the soil surface—over 90% of all roots, and virtually all structural supporting roots, are in the upper 60 cm of soil. Soil disturbance within the rooting area should be avoided as this can significantly affect the tree stability and moisture uptake.
Vegetation type/species—Identifying species allows for understanding tree characteristics i.e., advantageous root systems, brittle/robust structure and allowing categorising water demand for reference 5. Vegetation species is also important profiling outbreaks of disease.
Vegetation water demand—Trees can be categorised by the amount of water they take from the ground. The amount of water a tree takes from a soil with high Plasticity Index (PI) is fundamental to the potential to cause ground instability/subsidence the more water extracted from soil with high PI means the more soil shrinks by volume. This also links directly to climate warming, increased tree growth due to climate warming increases demand of water for a tree to sustain increased growth. Being able to determine tree health also helps to mitigate risk. If a tree is in poor health its water demand will be diminishing therefore reducing risk. These factors can be monitored (e.g. annually) by refreshed satellite data.
Vegetation health—Understanding vegetation health determines further risk. An early mature tree with high water demand on a soil with high PI would be a high risk. But through identifying tree health via satellite or hyperspectral sensor through chlorophyll and spectral changes in tree leaf can de-risk a property considerably.
Vegetation life expectancy—Associating life expectancy by species gives an estimated expiry date for risk by either tree or site.
Vegetation pruning tolerance—Trees react in different ways when pruned. This may increase water demand as the tree fights to create larger leaves in order to restore photosynthesis for food production and to carry out the compartmentalisation of decay process to protect against infection or decay post pruning operations.
Vegetation Height—the height of vegetation can be used to determine whether or not property is likely to be damaged if the vegetation falls. It can also be used as a proxy measurement for the extent of the vegetation's roots (potentially together with the vegetation species/type). Historical Low Earth Orbit (LEO) or Light Detection and Ranging (LiDAR) data may be used to determine the annual reduction in height of a tree. This may be due to natural aging process or poor tree health/vigour.
Vegetation Density

Each of the above vegetation features, and in particular when taken in combination, allows for a risk posed by vegetation to an item to be determined, as will be described in more detail below.

The type of soil 104 may have a large impact on the risk profile, in particular in relation to subsidence risk and/or the risk of vegetation falling. If such aspects of a risk profile are to be determined, the soil type around the property may be received. Information relating to the type of soil may be determined directly—for example from multispectral satellite imagery and/or LiDAR which can determine sub-ground structure. Alternatively, information relating to soil type may be determined from a suitable database and associated with the location from the directly measured data—e.g. the location of the area around the property may be overlaid with the corresponding area from a soil type map.

One metric of soil type relevant to subsidence risk is its ‘plasticity index’ (PI). PI is the difference between the soils Liquid Limit (LL) and Plastic Limit (PL) The PI is the size and range of water contents where the soil exhibits plastic properties. A high PI would indicate a clay soil which can shrink in months without rain fall or by extraction of moisture by vegetation. The reversal of moisture extraction (i.e. tree removal) or periods of excessive rain fall, clay particles in soil with high PI expand causing “Heave”, another form of ground instability.

The data relating to vegetation feature (and optionally soil type) is then processed and a risk is determined at step 106. Rules as to how vegetation feature data is combined and converted into a specific risk are stored in database 108. The risk may include information as to how certain risks may be reduced if remedial action is undertaken. In such an example, rules as to how remedial actions may affect certain risks are stored in database 110—which may be the same database as 108.

The final step is to output a risk 112.

FIG. 2 shows an apparatus 200 adapted to carry out the method described with reference to FIG. 1.

The apparatus 200 comprises an input module 202, a processor 204 and associated memory 206, and an output module 208. In use, data (such as satellite imagery) is input into the input module 202. This data originates from one or more high altitude sources (such as satellites 210) and is received on the ground by a (satellite) base station 212. This data is then processed using the processor 204 and associated memory 206 to produce an appropriate risk. This risk is then outputted to a user via output module 208.

### Data Collection

Passive data from a high altitude source (such as from orbit, e.g. from a satellite) has a number of advantages compared to, for example, utilising data taken from the ground or via an aircraft. It has surprisingly been found that passive high altitude data (such as satellite data) can be sufficient to determine the risk posed by vegetation, despite the significant reduction in resolution available compared to active, low altitude data (such as LiDAR data obtained from aircraft which typically fly below 10 km).

The quality of data from high altitude sources may be affected by weather (in particular, clouds affect the transmission of visible light). It may therefore be appropriate to only collect data under certain conditions.

In this specification, the term ‘passive’ or ‘passive data’ means data which is collected by observations—as opposed to ‘active’ data where some active interaction (such as shining a laser beam at the surface) is required. Passive data collection allows for efficient, cheap and fast analysis without the need for complicated and expensive active data collection equipment. For example passively collecting light from vegetation allows for the colouration (in the visible spectrum and beyond) of foliage to be analysed (as is discussed in more detail below).

Low Earth Orbit (LEO) satellites are particularly advantageous.

LEO satellites orbit the Earth, and collect data, at altitudes between 160 km and 2,000 km, typically above around 500 km. LEO satellites at an altitude of around 500 km typically have an inclination angle at the equator of around 98°. As they pass over a given point on the ground, LEO satellites have a ground track speed of around 7.8 km/s. They acquire images as they pass over a given point—creating a ‘swath’ of images.

LEO satellites orbit at relatively low altitudes compared to satellites in geostationary orbit so they can acquire higher resolution (higher level of detail) imagery which would not be possible from a similar satellite placed in geostationary orbit.

LEO satellite imagery depends strongly on the characteristics of the particular satellite system from which they were acquired, for example:
Scene size (swath)—how wide each image is (essentially the satellite's ‘field of view’). Large swath sizes would mean fewer passes would be needed to cover a particular area, but the resolution would likely be lower.
Resolution—The resolution determines what features may be distinguishable from one another. For example, it would be possible to distinguish individual trees within a forest in a high resolution image, but only the forest from other features (e.g. property, rivers etc.) in lower resolution images. Higher resolution is advantageous in accurately determining vegetation features, but a lower resolution may be sufficient for certain purposes.
Repeat period—The frequency with which a satellite can return to a given location with the same viewing parameters is called the repeat period. For many satellites this is in the order of anything from 11 to 36 days or even longer. However, the revisit capability may be far shorter since the satellite may be able to view the area of interest from different viewing angles or may employ several satellites in a constellation. Hence, revisit periods can be as short as 1 day.
Data Cost—some satellites are multi-purpose and as such collect data which is very inexpensive (or indeed free). Specialist satellites on the other hand tend to have very high data costs so as to recoup the very high cost of satellite launch and maintenance.

There is a trade-off between the coverage capability of a system and its resolution. This is illustrated in FIG. 3 with some representative scene sizes from several systems (namely Sentinel-2 (300), Landsat-8 (302), RapidEye (304) and Pleiades (306)).

If wide areas are required to be covered, in practice it would take a long time to obtain lots of small, higher resolution images to cover the area compared to lower-resolution images, and it would be extremely expensive to achieve. For example, it would take 210 separate Pleiades images to cover the same area as a single Sentinel-2 scene. To acquire this many Pleaides scenes would take several days in theory, and realistically several weeks, especially given the prevalence of cloud coverage. Hence, from a practical perspective, this approach would only be appropriate if the application required particularly high resolution data and that the long time period taken to cover the whole area would be acceptable.

FIG. 3 cites two resolution options for most of the individual satellite systems. This is because satellites operate at different resolutions for different wavelengths of light. For example, Sentinel-2 offers Blue, Green, Red, and Near-Infrared at 10 m resolution, but other bands e.g. Red-Edge bands, may only be available at 20 m. This difference in resolution is a physical property of electromagnetic radiation, and can be exploited as is described below with reference to FIG. 4.

Systems such as Landsat and Sentinel are on fixed acquisition schedules, routinely acquiring imagery over large areas. As a result, these systems will have extensive archives of data over a given location. In contrast, satellites such as Pleiades or RapidEye are ‘taskable’, meaning that they will only acquire an image when tasked to do so. Hence, their revisit is determined by customer request and the availability of archive data depends on whether anyone has previously requested data over that particular area.

An important factor in monitoring vegetation from space (or indeed at all) is the temporal aspect of vegetation growth and appearance. The difference over the seasons means that like-for-like comparison would require additional processing. This is especially true for broad-leafed trees which have particularly strong bright greens early on in the season, and these leaves darken as the season progresses. In order to accurate compare images of the same area the two images should be taken at a similar point in the season. For example, the images may be temporally separated by a growing season—typically one year. It should be noted that the variation in tree canopies during the growing season can be highly informative and can reveal detailed information on type and condition of tree that may not be possible to obtain from a single image.

Satellites are particularly well suited to determine and analyse how vegetation changes over time. This may involve the appearance of new vegetation at a location or the removal of vegetation from a site. Change detection techniques can be extremely subtle and spot small scale differences, but they may also need to take account of the season so that like for like comparisons can be made. Again, the level of information retrievable will depend on system resolution. It should be pointed out that, far less information on tree canopies is retrievable during the winter, when trees are leaf off. Hence, data is usually best retrieved to leaf-on scenarios.

It will be appreciated that more than two scans of the same area could be used to improve the accuracy of the growth model, and that the scans may be temporally separated by more or less than one year, for example by one or two growing seasons, preferably by at least one growing season. Furthermore, data from similar vegetation (for example, those experiencing a similar climate) may be applied to other vegetation so as to provide an indication of future growth.

Satellites are able to detect where vegetation is and is not. This can be divided up into different types of vegetation e.g. shrubs, trees, (deciduous, coniferous), crops etc. The exact type of vegetation will be dependent on system resolution (i.e. individual trees vs groups of trees). More discrimination capability between different classes of vegetation will be obtained if more than one image (i.e. a time series) is obtained.

As referred to above—the optical imagery will be sensitive to the colour of the vegetation, which in turn can be related to the chlorophyll content, leaf area index and various other factors pertaining to the status of the vegetation.

Satellites are able to image in visible light, but also in other wavelengths of light—for example near infrared, or red-edge bands. Imaging vegetation in these wavelengths can reveal more information about the state or health of the vegetation as illustrated in FIG. 4.

FIG. 4 shows a graph showing the reflectance (the proportion of light being reflected) of vegetation over a range of wavelengths. Visible light spans from around 400 nm (blue) to 700 nm (red), and ‘near infra-red’ is defined as the area of the spectrum above red (in terms of wavelength), from 700 nm up to 2500 nm, or 950 nm as shown in FIG. 4. Such a ‘hyper-spectral’ analysis, where a range of wavelengths are analysed, can determine whether, for example, the tree/woodland is stressed for some reason, or whether it is suffering from die-back. Alternatively, a ‘multispectral’ analysis where a number of selected wavelengths are analysed—for example in the example shown in FIG. 4, the difference between 550 nm and 900 nm reflectivity could be used to determine whether the vegetation is healthy or not. Multispectral analysis would likely involve simpler and cheaper equipment, but hyperspectral analysis would be able to analyse further differences (for example if different vegetation has different wavelengths of interest).

In order to determine whether vegetation is dead or dying, it may be necessary to record a time series of information—for example a time series of 900 nm reflectivity may show that the vegetation is becoming less (or more) healthy. The change in health of vegetation (or indeed any other time-dependent property of vegetation) is important as the changing properties of vegetation may affect the future risk. For example, knowing that vegetation is becoming less healthy may indicate that at some point in the future the soil around the root structure may become less stable (especially following heavy rain) thereby increasing the risk to property from subsidence.

Traditionally, surface imaging optical satellites look vertically down on the Earth's surface. With these systems it may not be possible to accurately derive information about the height of objects on the surface. It is possible to infer tree height from texture information, but this is not particularly accurate. An alternative approach uses two images (known as stereo pairs) with slightly different viewing angles to derive some information on height. This gives much more accurate information but the cost is generally very high, especially for wide area coverage. As such, the use of stereo pairs of satellite images may suit woodland better than individual trees. A single satellite may be used to record a stereo pair of images—one image ‘looking forward’ as it moves along a swath, and another image ‘looking backwards’. Due to the high speed of satellites these images would likely be very close to one-another in time. However, this requires the satellite to have two camera positions, or a repositionable camera. Alternatively, two satellites travelling along the same (or similar) orbit can image the same area but from different angles.

A combination of information on image texture variations with spectral information can be used to infer information on canopy height. Note that the circumstances under which this method works will be site specific. Generally, these are grouped into broad classes e.g. e.g. 0-0.5 m high, 0.5-2 m high, 2-5 m high, above 5 m high etc. This does not provide detailed information on canopy growth, but does provide coarse estimates which may be useful in certain scenarios (e.g. for evaluating where vegetation is likely to present a fall risk).

### Data Processing

Table 1 below shows an example of cross-referencing and linking of vegetation features and/or remedial actions:

TABLE 1

| No. | Type | Title | Exemplary links |
|---|---|---|---|
| 1 | Initial | Property Geographical Location | All others |
| | | (GPS) | |
| 2 | Initial | Soil Type - Plasticity | 3, 4, 5, 6, 7 |
| | | Index (PI) | If remedial action, |
| | | | also 8, 9, 10 |
| 3 | Initial | Vegetation distance | 2, 4, 5, 6, 7 |
| | | from property | If remedial action, |
| | | | also 8, 9, 10 |
| 4 | Initial | Vegetation Species - | 2, 3, 6, 7 |
| | | | If remedial action, |
| | | | also 8, 9, 10 |
| 5 | Initial | Vegetation Type - | 2, 3, 4, 6, 7 |
| | | water demand - | If remedial action, |
| | | Low, Medium, High (BS5837) | also 8, 9, 10 |
| 6 | Initial | Vegetation Health | 2, 3, 4, 5, 7 |
| | | | If remedial action, |
| | | | also 8, 9, 10 |
| 7 | Initial | Life Expectancy | 2, 3, 4, 5, 6 |
| | | | If remedial action, |
| | | | also 8, 9, 10 |
| 8 | Remedial | Pruning tolerance | 2, 3, 4, 5, 6, 7 |
| 9 | Remedial | Vegetation removal | 2, 3, 4, 5, 6, 7 |
| 10 | Remedial | Planting | 2, 3, 4, 5, 6, 7 |

‘Initial’ refers to data which is actually measured (or inferred from actual measurements) and is to be analysed. ‘Remedial’ refers to data which is determined from modelling a remedial/mitigating action such as pruning, tree removal or planting.

The location (No. 1) is the core measurement and all other data is associated with all other data—in particular soil type which is location specific.

The vegetation features may be determined from the received satellite data by a trained classifier. For example, an imaging processing application may be adapted to determine what species a particular tree is depending on features of the image (e.g. colour of pixels, edge detection etc.). In one example, the trained classifier is a neural network. Convolutional neural networks are particularly well suited to pattern recognition in images. The training of the trained classifier may take the form of training data being inputted into the network where a known result is to be expected. The model employed by the trained classifier would then be adjusted until a specified cost function is minimised. The more training data (and indeed the higher the quality of the training data) would result in a more accurate and efficient model.

The trained classifier may be self-learning, for example learning either on- or off-line or both. The trained classifier may employ ‘reinforcement learning’ may be employed whereby a user modifies or corrects the risk for one or more outputs, with the classifier learning from this interaction.

The cross-references indicate where other features are used to infer further features—for example ‘life expectancy’ cannot be measured directly, but can be inferred from other vegetation features such as vegetation type, health etc.

The cross references also provide further insight when determining a risk for a property as the various vegetation features may have non-linear interactions. For example, the water uptake of a particular piece of vegetation would usually be determined by its species and size—but its health would significantly impact upon this.

Furthermore, there will be cross references between different items of vegetation—for example if there is vegetation with low health, this may be indicative of a disease or unsustainable growing conditions and therefore indicative that other vegetation may become unhealthy in the future.

It should be appreciated that in some scenarios it may not be possible or practical to determine all of the above vegetation features based on the available data. In such circumstances, a risk may still be generated, but may be at a lower confidence level than compared to if more vegetation features were determined from the data.

In particular it may not be necessary to determine the ‘remedial’ vegetation features—for example if remedial action is not contemplated.

The available and appropriate data is collated and processed based on a series of rules which determine particular classes of risk.

In one example, the rules and how data (and what type of data) is processed are modified over time based on improved knowledge of risk. This may be achieved by a trained classifier such as a neural network. The training of the trained classifier may take the form of training data being inputted into the network where a known result is to be expected. The model employed by the trained classifier would then be adjusted until a specified cost function is minimised. The more training data (and indeed the higher the quality of the training data) would result in a more accurate and efficient model.

The trained classifier may be self-learning, for example learning either on- or off-line or both. The trained classifier may employ ‘reinforcement learning’ may be employed whereby a user modifies or corrects the risk for one or more outputs, with the classifier learning from this interaction.

The rules and interactions between the various features are stored in the ‘risk profiles’ database as shown in FIG. 1.

The models used to predict the effect of remedial actions are stored in the ‘remedial risk profiles’ database as shown in FIG. 1.

Further sources of data may be used in determining a risk, for example weather or climate data. Weather data may be able to predict (in the short term) subsidence risk. For example, if it is determined from soil type and vegetation that the soil is saturated (at field capacity) and may be unstable, a predicted storm or period of heavy rain may pose a particularly high risk.

With regard to climate, this can be used to predict in the longer term. For example, the growth rate vegetation can be inferred from climate data and risks associated with the growth can be forecast. Similarly, if climate predictions expect a hot, dry summer, this could be used to predict future vegetation health.

### Data Output

Once an appropriate risk has been generated, it is outputted to a user.

As discussed above, the risk may represent the current risk posed to property, or a future risk based on (for example) extrapolated vegetation growth/health features and/or expected weather/climate conditions.

In one example, the risk outputted to a user presents the current risk posed, and predictions (with associated confidence intervals) of the risk posed at various points in the future. Such an output enables a user to plan accordingly, for example to undertake mitigating activities.

The risk may be presented to the user via a user interface, for example via a website where the most up-to-date risk profile is posted.

In one example, the output splits risk by time period—such as ‘immediate risks’, ‘intermediate risks’ and ‘long term risks’. The time periods may be adjustable for the application, or the user may be able to modify the time periods.

The risk output may further comprise an indication of the confidence level of the risk—for example a range of risk scores may be presented as representing a particular confidence interval e.g. ‘the probability of vegetation induced property-damaging subsidence occurring within the next 12 months is 0.46, with a 95% confidence interval of 0.33-0.59’.

Alternatively or in addition, this information may be presented graphically to a user.

### Remedial Action

In some cases, the risk may indicate that by undertaking certain remedial actions, certain risks can be mitigated. Such remedial actions include pruning or removal of vegetation (which may reduce risks associated with vegetation encroachment), or planting vegetation (which may reduce risks associated with subsidence). The system may be used as a method of remedying risk to an item posed by vegetation, where remedial data is outputted to a user.

The remedial action may be specific—for example—‘Prune birch tree at position X so it is at least 2 m from property at position Y’, or more general—‘Plant new shrub-like vegetation around property’. Each category of vegetation has different associated risks, so the proposed remedial actions specify which type of vegetation to prune, remove or plant. Thus, when modelling potential remedial actions, potential side-effects of (for example) planting the wrong type of tree which will likely die due to local conditions, are considered.

The system may present, alongside recommended remedial actions, a statement of work for a contractor. Each category of vegetation danger has different remedial actions. It is thus useful for contractors to be able to know the category of vegetation so that they can deploy the appropriate personnel and tools and potentially to request permission from land-owners/network operators prior to a physical site inspection. This would reduce the time to complete the remedial action and avoid unnecessary costs due to resources (people and/or equipment) brought to site.

Following completion of remedial action the contractor may record new data—for example the location of recently planted vegetation and upload this to the apparatus 200 for processing. This data may be recorded by way of a handheld LiDAR apparatus that incorporates geospatial measurement and geo tagging of GPS locations. In such a way, accurate positions of recently cut/removed/planted vegetation can be recorded.

The apparatus 200 then determines the risk with the new ‘post-remedial action’ data and outputs an updated risk. This risk may be sent directly to the contractors so as to inform them whether or not the remedial action undertaken was sufficient to mitigate a specific risk or group of risks.

The present system allows for an audit of contractors' work to be undertaken, reducing the risk of incomplete/insufficient remedial action. FIG. 5 shows an extended flow diagram including a number steps if a remedial action is assigned 500.

The contractor receives the remedial action assignment and undertakes the remedial action 502. They then record new vegetation data 502 (for example, using a handheld LiDAR device). This new data is then sent to update a vegetation database 506 and the loop completes by (re-) determining vegetation features and risk profile 102/106.

Data recorded ‘on the ground’ by a contractor may also be used to improve the accuracy of the remotely obtained. For example if a contractor measures the height of a particular tree (e.g. using a handheld ranging device), this is likely to be more accurate than a similar measure taken from satellite imagery, and the height of a tree is unlikely to have changed significantly between the two measurements. The information held in a central database related to that vegetation can then be updated. This database update may prompt a risk re-categorisation of nearby property.

### Alternatives and Modifications

Various other modifications will be apparent to those skilled in the art for example it is possible for Low Earth Orbit satellites to utilise active techniques such as LiDAR whereby light is back-scattered off vegetation to accurately determine canopy height and extent. This results in very high accuracy imaging, especially of vegetation height, but would require specialist satellites.

It would be possible for the system described herein to utilise data from other sources, such as from high altitude aircraft (at altitudes in excess of 10 km), drones, balloons (which typically fly at between 15-40 km, and potentially in excess of 50 km) either in addition to, or instead of satellite data. Such alternative sources of data may not be able to cover large areas in a short amount of time, but the resolution would likely be higher.

‘On the ground’ data may be collected in other ways than using back reflecting laser beams. One alternative would be to use surveying techniques using a theodolite, an electronic distance meter (or combined in one device, for example as a ‘total station’).

It will be understood that the present invention has been described above purely by way of example, and modifications of detail can be made within the scope of the invention.

Reference numerals appearing in the claims are by way of illustration only and shall have no limiting effect on the scope of the claims.

What is claimed is:

1. A method of determining the risk to an item posed by vegetation, the method comprising:
receiving passive high altitude data, such as satellite imagery, relating to vegetation around the item;
determining at least one vegetation feature based on said data;
determining a risk posed to the item based on said at least one vegetation feature; and
outputting said risk to a user.

2. A method according to any preceding claim wherein said passive high altitude data is collected from an altitude of at least 10 km.

3. A method according to any preceding claim wherein said passive high altitude data is collected from an altitude of at least 15 km.

4. A method according to any preceding claim wherein said passive high altitude data is collected from an altitude of at least 500 km.

5. A method according to any of claims 1 to 3 wherein said passive high altitude data is collected from an altitude of between 160 km to 2,000 km.

6. A method according to any preceding claim wherein said passive high altitude data comprises satellite imagery.

7. A method according to any preceding claim wherein said passive high altitude data comprises multiple images of the vegetation around the item, said multiple images being taken from different angles.

8. A method according to claim 7 wherein said passive high altitude data comprises stereo satellite imagery.

9. A method according to any preceding claim wherein said passive high altitude comprises multispectral imagery.

10. A method according to any preceding claim wherein said passive high altitude data comprises hyperspectral imagery.

11. A method according to any preceding claim wherein said passive high altitude data comprises infra-red imagery.

12. A method according to any preceding claim comprising receiving further passive high altitude data relating to vegetation around said item, said further passive high altitude data being temporally separated from the passive high altitude data.

13. A method according to any preceding claim further comprising receiving data relating to soil type around said item.

14. A method according to claim 13 wherein said data relating to soil type comprises data relating to soil plasticity around said item.

15. A method according to any preceding claim further comprising receiving climate data and determining at least one vegetation feature based on said climate information.

16. A method according to any preceding claim further comprising receiving weather data and determining at least one vegetation feature based on said weather information.

17. A method according to claim 15 or 16 wherein said at least one vegetation feature based on said climate or weather information comprises risk of falling.

18. A method according to any of claims 15 to 17 wherein said at least one vegetation feature based on said climate or weather information comprises water uptake prediction.

19. A method according to any of claims 15 to 18 wherein said at least one vegetation feature based on said climate or weather information comprises future vegetation health.

20. A method according to any preceding claim wherein said item comprises property.

21. A method according to claim 20 wherein said property comprises a structure such as a building.

22. A method according to any preceding claim wherein said data around the item comprises data relating to vegetation within 70 m of said item.

23. A method according to any preceding claim wherein said data around the item comprises data relating to vegetation within 7 m of said item.

24. A method according to any preceding claim further comprising receiving LiDAR data relating to vegetation around the item.

25. A method according to claim 24 further comprising determining sub-ground structure based on said LiDAR data.

26. A method according to claim 24 or 25 further comprising determining vegetation height based on said LiDAR data.

27. A method according to any preceding claim wherein said at least one vegetation feature comprises distance from the item.

28. A method according to any preceding claim wherein said at least one vegetation feature comprises vegetation height.

29. A method according to any preceding claim wherein said at least one vegetation feature comprises vegetation density.

30. A method according to any preceding claim wherein said at least one vegetation feature comprises vegetation type.

31. A method according to any preceding claim wherein said at least one vegetation feature comprises vegetation life expectancy.

32. A method according to any preceding claim wherein said at least one vegetation feature comprises vegetation health.

33. A method according to any preceding claim wherein said at least one vegetation feature comprises vegetation water uptake.

34. A method according to any preceding claim wherein said at least one vegetation feature comprises vegetation pruning tolerance.

35. A method according to any preceding claim wherein a trained classifier is used to determine said at least one vegetation feature from said received satellite data.

36. A method according to any preceding claim wherein a trained classifier is used to determine the risk profile based on said at least one vegetation feature.

37. A method according to claim 35 or 36 wherein said trained classifier comprises a neural network.

38. A method according to claim 37 wherein said neural network is a convolutional neural network.

39. A method according to any of claims 35 to 38 wherein said trained classifier is adapted to employ reinforcement learning.

40. A method according to any preceding claim wherein said risk comprises a subsidence risk.

41. A method according to any preceding claim wherein the risk comprises a current risk posed to the item.

42. A method according to any preceding claim wherein the risk comprises a risk posed to the item at a future point in time.

43. A method according to any preceding claim wherein said risk comprises a probability of an event occurring within a specified time frame.

44. A method according to any preceding claim wherein said output is provided to a user via a user interface.

45. A method according to any preceding claim further comprising providing a confidence level associated with said risk.

46. A method according to claim 45 wherein said confidence level comprises a confidence interval.

47. A method according to any preceding claim further comprising determining a remedial action in dependence on said risk.

48. A method according to claim 47 wherein said remedial action comprises pruning or removing vegetation around the item.

49. A method according to claim 47 or 48 wherein said remedial action comprises planting vegetation around the item.

50. A method according to claim 48 or 49 wherein said remedial action is dependent on the type of vegetation.

51. A method according to any of claims 47 to 50 further comprising the step of receiving updated data following remedial action and determining one or more updated vegetation features in dependence on said updated data.

52. A method according to claim 51 further comprising the step of determining an updated risk in dependence on said at least one updated vegetation feature.

53. A system for determining the risk posed to an item by vegetation, the system comprising:
means for receiving passive high altitude data, such as satellite imagery, relating to vegetation around the item;
means for determining at least one vegetation feature based on said data;
means for determining a risk based on said at least one vegetation feature; and
means for outputting said risk to a user.

54. A system according to claim 53 further comprising at least one satellite adapted to provide passive high altitude data relating to vegetation around the item.

55. A system according to claim 54 wherein said satellite comprises a multispectral camera.

56. A system according to any of claims 53 to 55 wherein the means for receiving passive high altitude comprises a satellite base station.

57. A system according to any of claims 51 to 56 further comprising means for receiving LiDAR data.

58. A system according to any of claims 53 to 57 further comprising means to carry out the method of any of claims 1 to 52.

59. A computer program product comprising software adapted to carry out the method of any of claims 1 to 52.

60. An apparatus adapted to execute the computer program product of claim 59.
